(19) United States
(12) Patent Application Publication
(10) Pub. No.: US 2023/0068493 A1
(43) Pub. Date: Mar. 2, 2023

(54) Using Capacitive Deionization to Desalinate Water and Manage Power for a Hydrogen Electrolyzer System

(71) Applicant: Patrick Michael Curran, Laguna Niguel, CA (US)

(72) Inventor: Patrick Michael Curran, Laguna Niguel, CA (US)

(21) Appl. No.: 17/300,592

(22) Filed: Aug. 28, 2021

(51) Int. Cl. C02F 1/469

(52) U.S. Cl. CPC C02F 1/4691; C02F 2103/08

(57) ABSTRACT

This invention relates to a high-performance, low-cost water capacitive deionization and hydrogen electrolyzer system that can operate from AC or DC power sources and manage and store power when coupled with renewable energy sources.

### CROSS-REFERENCE TO RELATED APPLICATIONS

This application claims the benefit of provisional patent application Ser. No. 63/103,892 filed Aug. 29, 2020 by the present inventors.

### FEDERALLY SPONSORED RESEARCH

Not applicable

### SEQUENCE LISTING OR PROGRAM

Not applicable

### FIELD OF CLASSIFICATION SEARCH

N/A

### BACKGROUND OF INVENTION

### Field of Invention

This invention relates to using a capacitive deionization system to desalinate water to feed to a hydrogen electrolyzing device such as but not limited to those used to produce green hydrogen via electrolysis. The direct current (DC) powered system could also include power to be supplied by a renewable energy source such as solar energy system, which outputs only DC voltage which both the capacitive deionization system and electrolyzer can use directly.

### Current State of the Art

There are water systems that can produce demineralized water (DI water) for use by hydrogen electrolyzers such as reverse osmosis (RO). But, the performance of this technology has major deficiencies, which are described below.

The energy of reverse osmosis per cubic meter or gallon of water produced is much higher than capacitive deionization. See table below. The kWhr/m3 of clean water produced by reverse osmosis is approximately 1.0.

The reverse osmosis systems also have very high chemical, electrical, and mechanical maintenance due to the propensity to foul the membrane because of intolerable contaminants and high operating pressure.

### BACKGROUND OF THE INVENTION—OBJECTS AND ADVANTAGES

Accordingly, several objects and advantages of our invention are:

By using capacitive deionization (CapDI, or RDI) for the desalination of feed water for an electrolyzer system, the energy required to produce acceptable water will be less and the recovery of clean water will be higher, reducing the overall energy consumption of the system.

In addition, using the CapDI system to produce acceptable water will have lower capital cost and maintenance costs than state of the art desalination technologies for the electrolyzer such as reverse osmosis, electrodialysis, thermal distillation, etc.

By using capacitive deionization to produce the required water, it allows for the use of DC power directly from a solar array system to power the water system which will eliminate the energy conversion loses of converting DC from the solar system to the AC power for the desalination system.

An integrated solar/capacitive deionization/electrolyzer system will also be able to balance the power feed to the electrolyzer to allow for intermittent operation which is common with solar power feed.

The capacitive deionization system could also function as both a desalination system and a battery backup for the solar system for feeding power to the electrolyzer.

### BACKGROUND OF THE INVENTION—SUMMARY

This invention relates to system that uses a capacitive deionization system to generate deionized water for use by a hydrogen electrolyzer device that could produces hydrogen, oxygen, or other gases. The desalination system, and/or the electrolyzer could be powered by a solar power generation system directly without the use of energy storage batteries as both systems operate on direct current power and can accommodate the fluxuation in power. The system could also be designed such that the capacitive deionization system acts as both the desalination system and energy storage for the electrolyzer.

### DRAWINGS—FIGURES

FIG. 1: Capacitive deionization system feeding water to hydrogen electrolyzer system.

FIG. 2: Solar power coupled with capacitive deionization feeding water to electrolyzer.

FIG. 3: Solar power coupled with the entire capacitive deionization and electrolyzer systems.

FIG. 4: Capacitive deionization system design for desalination and/or energy storage.

FIG. 5: Summary of Capacitive Deionization vs. Reverse Osmosis operating costs.

FIG. 6: Details of Capacitive Deionization vs. Reverse Osmosis operating costs.

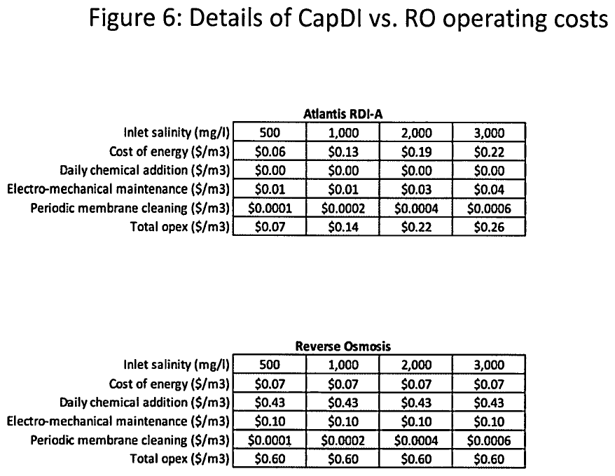

### DETAILED DESCRIPTION OF THE INVENTION

Capacitive deionization is a novel technology for the desalination of water. It has some unique properties that the state-of-the-art technology reverse osmosis does not have, which enables it to greatly improve the performance of a hydrogen electrolyzer system. These properties include Lower energy usage, higher clean water recovery, lower capital costs, lower operating costs, minimal use of chemicals, lower electrical and mechanical maintenance, ability to operate directly from DC power from solar, can store energy, and can balance the power usage of the entire system. Capacitive deionization works by removing the salts from water as it passes through an electric double layer capacitor. As the low-pressure water passes through, ions are removed, and the water passes out the end of the capacitor. This is the opposite of reverse osmosis which uses high pressure to push water through a membrane. In this case, the water is removed from the salty water. Capacitive deionization removes the salt from the salty water. This is a much easier way to desalinate water. Current capacitive deionization systems are not designed to produce the desalinated water needed for electrolysis. This invention describes not only how to produce the water quality needed for electrolyzer, but also the advantages of such a system to greatly improve the overall performance, equipment costs, and operating costs of the full system.

The production of hydrogen by electrolysis requires a fully desalinated water to not foul the system as well as produce unwanted gases such as chlorine. Both the desalination and electrolysis systems use energy to operate. 55% of the cost to produce hydrogen from electrolysis is energy and 33% is capital costs of the entire system. Systems that can reduce this 88% of the cost will enable green hydrogen to become competitive with fossil fuel sources of hydrogen and energy which will allow for the world to switch over to zero carbon footprint energy.

### Produce Fully Desalinated Water

Using CapDI to produce fully desalinated water (DI water) have not been done before. Our unique system design and operation have solved this problem. This is accomplished by placing desalination capacitors in series, utilizing multiple designs of capacitors, and a unique operating technique the recycles water through the system to ensure the high-quality requirement is met.

### Low Energy

By using capacitive deionization for the desalination of feed water to an electrolyzer system, the energy required to produce acceptable water will be less, reducing the overall energy consumption of the system. As previously described, 55% of the cost to produce green hydrogen is the overall energy of the system, which includes both the desalination and the hydrolysis. Capacitive deionization can produce the required quality of water for 0.2-0.8 kWhr/m3. Reverse osmosis requires 1.0-2.0 kWhr/m3. This advantage will reduce the 55% energy load of the system to approximately 50%, a 10% savings.

### High Recovery

When using renewable energy sources such as solar to produce green hydrogen, the systems are generally located in water scarce areas with low cloud cover such as the middle east, deserts of California, etc. Conservation of the available water is very important. Therefore, high water recovery is important for the stability of the operating.

The quality of water produced by a single stage RO system contains approximately 20 ppm of salt, which is not sufficient for use in hydrolysis. Consequently, a second RO system must be used to process the clean, or permeate, of the first system to produce water below 1 ppm of salt.

When two system are used in tandem to produce the required quality level of water, the recovery is reduced. Typically, the recovery of a single system is 75%. If a second system is used to process the clean water from system 1 with a similar recovery, then the overall recovery of the system is 50-75%.

Capacitive deionization can operate as high as 95% recovery with a single system. This can be done because of the unique operating parameters. Water can be conserved during the brine generation, can be recycled, and used to purge the system again, and the brine can also be treatment to further increase the recovery.

### Low Capital Costs

Typical reverse osmosis (RO) system costs for the low salinity water used to feed the hydrolysis cells is approximately $1,500USD per gpm (gallon per minute). The size of the RO system is not reduced if the inlet salinity is already low. Capacitive deionization (CapDI) system is sized based on the incoming salinity. So, low salinity applications like this require a smaller system than normal, resulting in capital costs that approximately 60% of RO. This helps reduce the portion of the green hydrogen capital from 33% by a few percentage points.

### Low Operating Costs

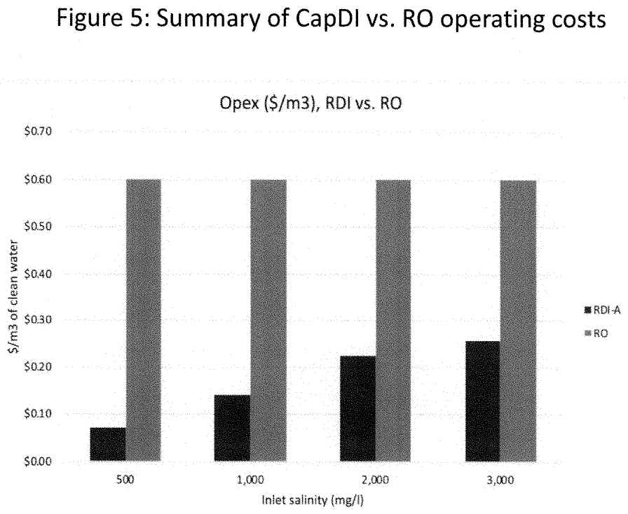

RO systems have 3 major components of significant maintenance. First is the continuous feeding of chemicals to maintain the performance of the system. Second is high electrical costs during the large pumps needed to push the water through the membrane. Third is high mechanical maintenance due to the high operating pressures. All these very intense maintenance activities add approximately $0.50/m3 to the cost of production of the water. See summary and details in FIGS. 5 & 6.

CapDI avoids all three of these large costs. There is no requirement for constant feeding of chemicals, only periodically to clean the system. The electrical maintenance is very low because of the simple components of construction and small pumps. The mechanical maintenance is also very low because CapDI operates at 10% of the pressure of RO.

Operate Directly Off DC Power from Renewables

Capacitive deionization uses DC powered capacitors to remove salt from water. The capacitors and every other component on the system either already runs on DC power or can be easily substituted for one that does. This is not possible with reverse osmosis systems as they absolutely require AC power for the high-pressure pumps that are required. It is also very difficult for and expensive for electrodialysis to operate solely on DC power as their power rectifiers are complex and use AC power currently.

By using capacitive deionization to produce the required water, it allows for the use of DC power directly from a solar array system to power the water system which will eliminate the energy conversion loses of converting DC from the solar system to the AC power that would be needed for RO. This further reduces the CapDI energy usage for a renewal project by 5-25%, above and beyond the lower energy usage mentioned above.

### Act as Energy Storage and Power Balancing

The capacitive deionization system can function as a desalination system, an energy storage backup for the solar system, and store energy in the form of desalinated water.

Since the capacitive deionization capacitors operate with DC voltage/current and are also energy storage devices, part or all the system could act as a battery to store power during times where water is either partially or fully not needed and support the smooth operation of the electrolyzer. The system could also produce and store desalinated water during times of high energy production by the renewable source, essentially storing the energy in the form of water. With this flexibility, the smart CapDI system can adjust power usage to maintain constant production of hydrogen.

An integrated solar/capacitive deionization/electrolyzer system will also be able to balance the power feed to the electrolyzer to allow for intermittent power feeding which is common with solar power feed without use of lead-acid or lithium-ion batteries. This will be managed through an artificial intelligence-based power management controller that will determine which of the overall system components gets powered, always ensuring the most optimum and efficient combination is in use.

### Example 1

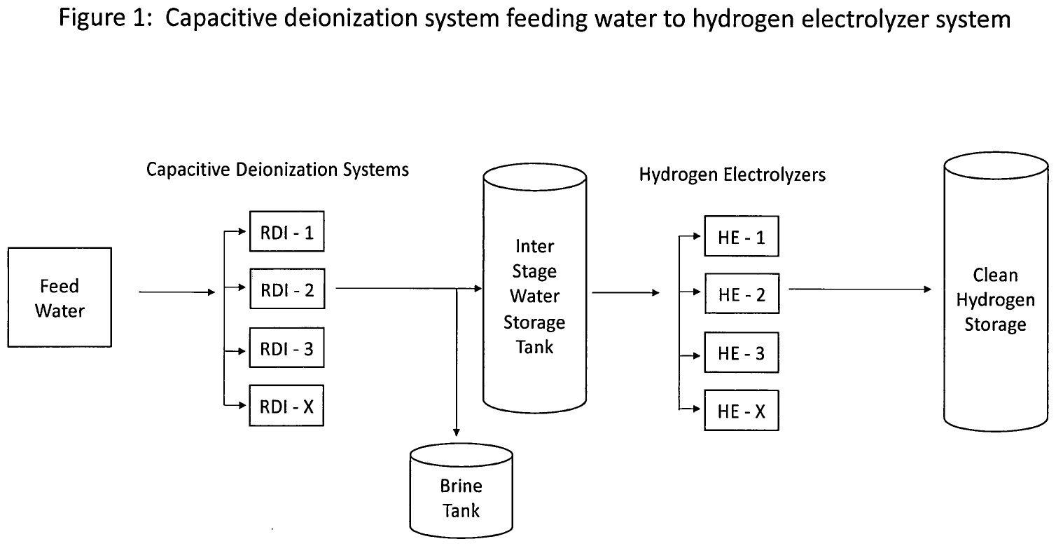

A capacitive deionization system that desalinates water to the quality level needed for use by a hydrogen electrolyzer cell as shown in FIG. 1.

### Example 2

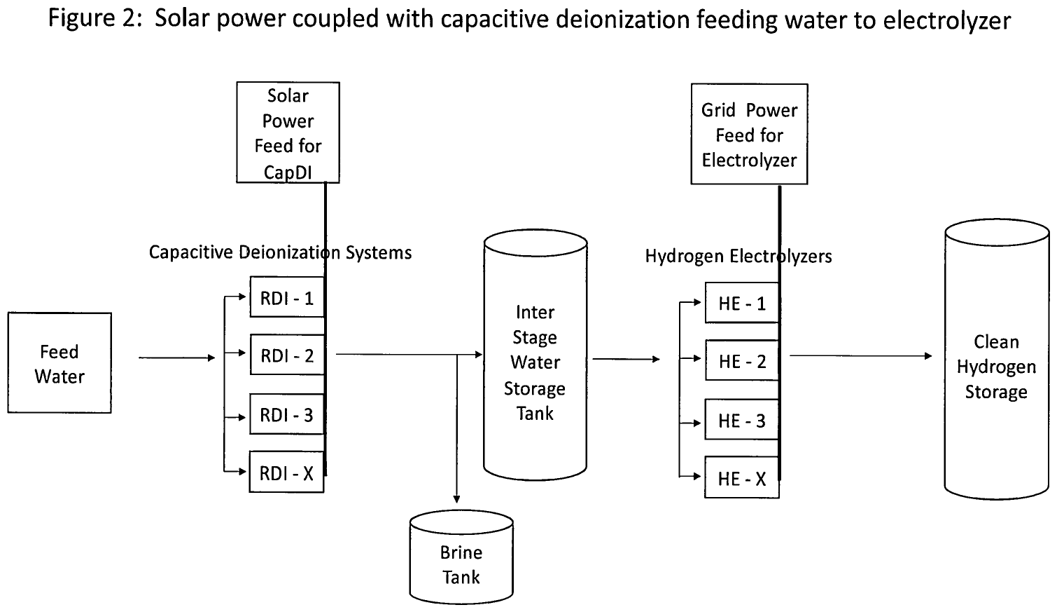

A capacitive deionization system that is directly powered by DC power from a solar system, avoiding the conversion to AC power, to produce desalinated water for use by a hydrogen electrolyzer cell as shown in FIG. 2.

### Example 3

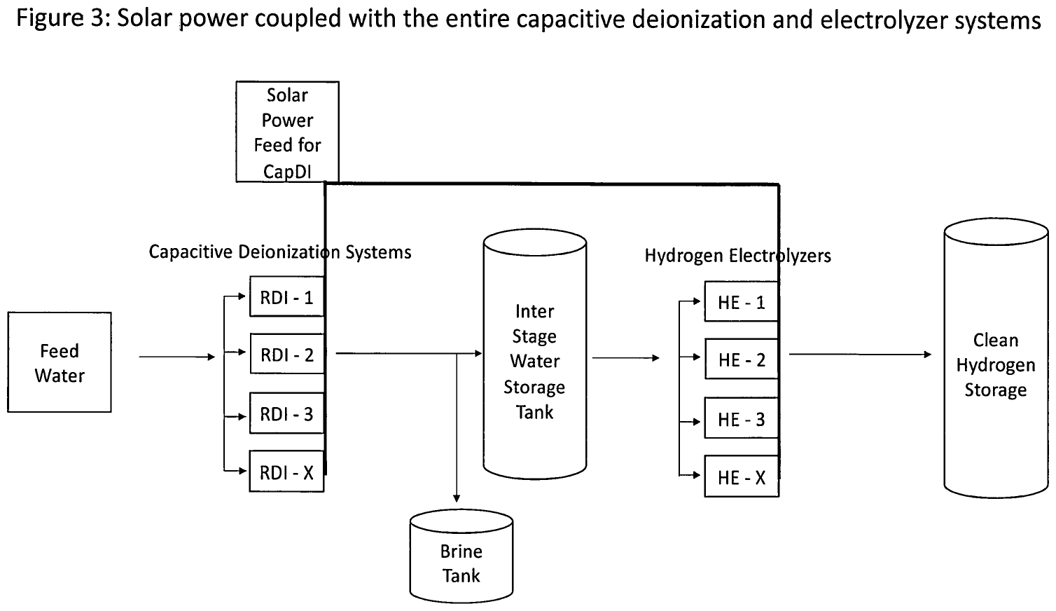

A capacitive deionization system and hydrogen electrolyzer that are both directly powered by DC power from a solar system, producing desalinated water for use by a hydrogen electrolyzer cell as shown in FIG. 3.

### Example 4

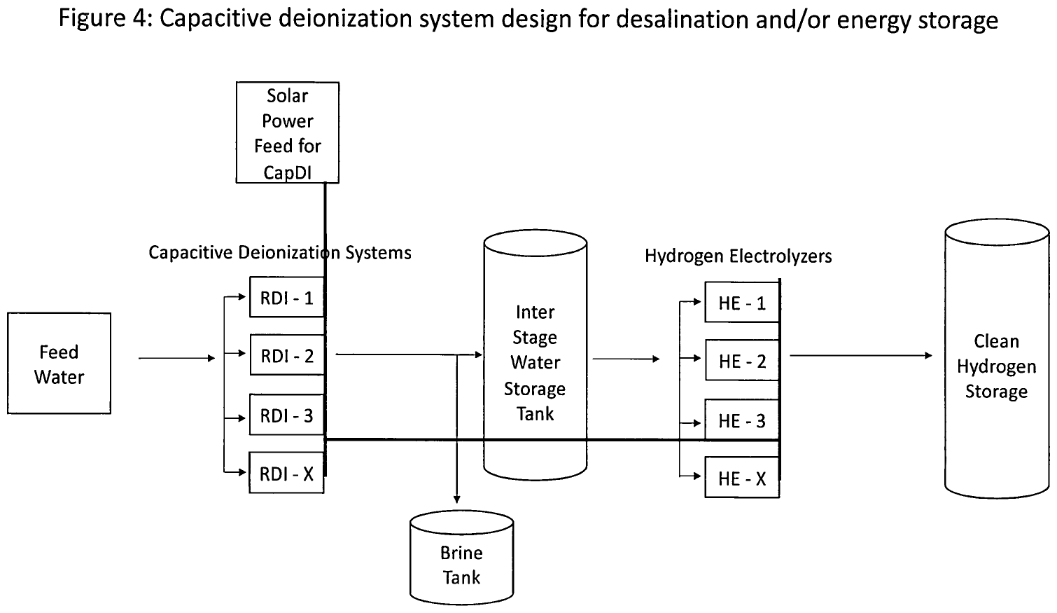

A capacitive deionization system and hydrogen electrolyzer that are both directly powered by DC power from a solar system that desalinates water for use by a hydrogen electrolyzer cell, and the capacitive deionization system manages power for the entire system. In this case, the CapDI system monitors and controls the power distribution for all system components. For example, when the incoming power is not sufficient to operate all system, power will be diverted to the electrolyzer to maintain production of hydrogen as shown in FIG. 4.

### Example 5

A capacitive deionization system and hydrogen electrolyzer that are both directly powered by DC power from a solar system that desalinates water for use by a hydrogen electrolyzer cell, and the capacitive deionization system manages the power for the entire system by also storing power in its capacitors to protect the hydrolyzer during periods of low incoming power or producing excess water during periods of excess power.

1. A hydrogen electrolyzer system consisting of:
a. A system and process to generate hydrogen consisting of the following:
i. A deionization system (such as and not limited to capacitive deionization) to remove dissolved salts from the water to an effluent suitable for electrolysis.
ii. An electrolysis system or cell that will use treated water to generate hydrogen.

2. A hydrogen electrolyzer system consisting of:
a. A system and process to generate hydrogen consisting of the following:
i. A solar array consisting of only panels and charge controller to power a either a capacitive deionization and/or electrolyzer system.
ii. A capacitive deionization system to remove dissolved salts or treating water to an effluent suitable for electrolysis.
iii. An electrolysis system or cell that will use treated water to generate hydrogen.

3. A hydrogen electrolyzer system consisting of:
a. A system and process to generate hydrogen consisting of the following:
i. A solar array consisting of only panels and charge controller to power a either a capacitive deionization and/or electrolyzer system.
ii. A modified capacitive deionization system to remove dissolved salts or treating water to an effluent suitable for electrolysis and store power for the electrolyzer system.
iii. an electrolysis system or cell that will use treated water to generate hydrogen.
